(19) United States
(12) Patent Application Publication
(10) Pub. No.: US 2011/0153482 A1
(43) Pub. Date: Jun. 23, 2011

(54) Method Of Providing Financial Planning Services

(76) Inventors: Christopher Conigliaro, Brooklyn, NY (US); Charles Hamowy, New York, NY (US)

(21) Appl. No.: 13/038,579

(22) Filed: Mar. 2, 2011

Related U.S. Application Data
(63) Continuation of application No. 11/064,189, filed on Feb. 23, 2005, now abandoned.

(51) Int. Cl. G06Q 40/00

(52) U.S. Cl. 705/35

(57) ABSTRACT

There is provided a streamlined method of providing personal, financial advice on an ongoing basis, wherein a financial planning year of a financial advisor and a plurality of clients is partitioned into predetermined and distinct portions having a predetermined, specific topic or group of topics which is the focus of each. It is contemplated within the scope of the method that the office resources of the financial advisor are devoted substantially exclusively to predetermined financial planning topics during each predetermined portion of the financial planning year such that the financial planning year of an advisor's office and each of a plurality of clients is substantially synchronized. The preferred method includes a financial planning year comprising first, second, third and fourth quarter portions, wherein during each quarter there occurs a meeting between an advisor and each of a plurality of clients the focus of which is the predetermined, specific topic pre-selected for the corresponding first, second, third and fourth quarter, respectively.

### FIELD OF THE INVENTION

The invention relates generally to a method of providing personal financial services and, in particular, to a system for providing financial services on an ongoing basis, wherein a financial planning year of a financial advisor and a plurality of clients is divided into distinct portions such that advisor-client meetings and office resources are devoted substantially exclusively to predetermined financial planning topics during predetermined portions of the financial planning year.

### BACKGROUND OF THE INVENTION

Conventional financial advisor-client relationships vary considerably depending on such factors as the particular style of the financial advisor, his or her brokerage firm, and/or the desires and needs of each client. Generally, however, most financial advisors endeavor to tailor their advice and efforts towards rendering services which are most beneficial to individual client needs. Because each client's particular life circumstances, assets, income, etc., are disparate, a financial advisor's manner of handling client investment portfolios differs widely from client to client. As a result of this disparity, a financial advisor's time and efforts are often devoted to nonspecific topics and, thus, mismanaged to the detriment of the financial advisor, his or her firm, staff and clients.

The quality of financial services and the efficiency with which such services are rendered could be improved and streamlined if there were a controlled system for providing financial services that incorporates the necessary tailoring of advice to particular client needs together with a structured system wherein meetings and office resources are devoted substantially exclusively to predetermined financial planning topics during predetermined portions of a financial planning year. In this manner, advisor-client meetings would occur on a regular (preferably quarterly) basis such that well-defined, pre-selected financial topics could be anticipated and discussed at each meeting. By directing a financial advisor's resources to a predetermined topic or group of topics during specific portions of a financial planning year, retention and focus of both the advisor and client would be increased, in addition to streamlining the advisor's workflow. Among the benefits of such a system would be improved client relations, enhanced time management, and less need for unscheduled client consultations between meetings.

### SUMMARY OF THE INVENTION

It is an object of the present invention to provide a method or system for providing financial services which affords the necessary tailoring of advice to accommodate specific client needs while simultaneously streamlining office workflow into general, predetermined topics of focus during predetermined portions of a given financial year.

It is a further object of the present invention to provide a method of rendering financial services on an ongoing basis through advisor-client meetings scheduled at regular intervals throughout a financial planning year

Yet another object of the present invention is to provide a synchronized financial planning year for a plurality of clients, wherein advisor-client meetings between a financial advisor and each of a plurality of clients are held during predetermined portions of the financial planning year; each portion of the year being devoted to a specific topic or group of topics.

In accordance with the foregoing objects and advantages, the present invention provides an improved method of rendering financial services. The method allows for organization and optimization of a financial advisor's office, staff and workflow to accommodate predetermined topics during predetermined portions of a financial planning year, such that the efficiency and performance of the financial advisor and his or her office staff is enhanced. In particular, the present invention relates to a method wherein a financial planning year is divided into distinct portions, such that during each portion there is a predetermined, specific financial topic or grouping of topics that are substantially exclusively the focus of each predetermined portion of the financial planning year.

It is preferred that the financial planning year as detailed herein is partitioned into four quarterly portions. It is desirable that during each quarter of the financial planning year, there is a meeting between the financial advisor and each of his or her plurality of clients, such that the financial planning year of each of the plurality of clients, including meetings and topics which are the focus thereof, is synchronized. That is, first, second, third and fourth meetings between the financial advisor and each of a plurality of clients, preferably focus on first, second, third and fourth predetermined, specific topics, respectively, during substantially the corresponding first, second, third and fourth quarters of the financial planning year.

### BRIEF DESCRIPTION OF THE DRAWINGS

The foregoing and other aspects and advantages of the invention will be better understood from the following detailed description of the invention with reference to the drawings in which:

FIG. 1 is a flow diagram of a method of providing structured financial planning services in accordance with the present invention, including an initial implementation period prior to integration of a client into the improved method of the invention; and

FIG. 2 is a detailed view of the method of providing structured financial services in accordance with the present invention, as set forth in Phase II in FIG. 1.

### DETAILED DESCRIPTION OF A PREFERRED EMBODIMENT

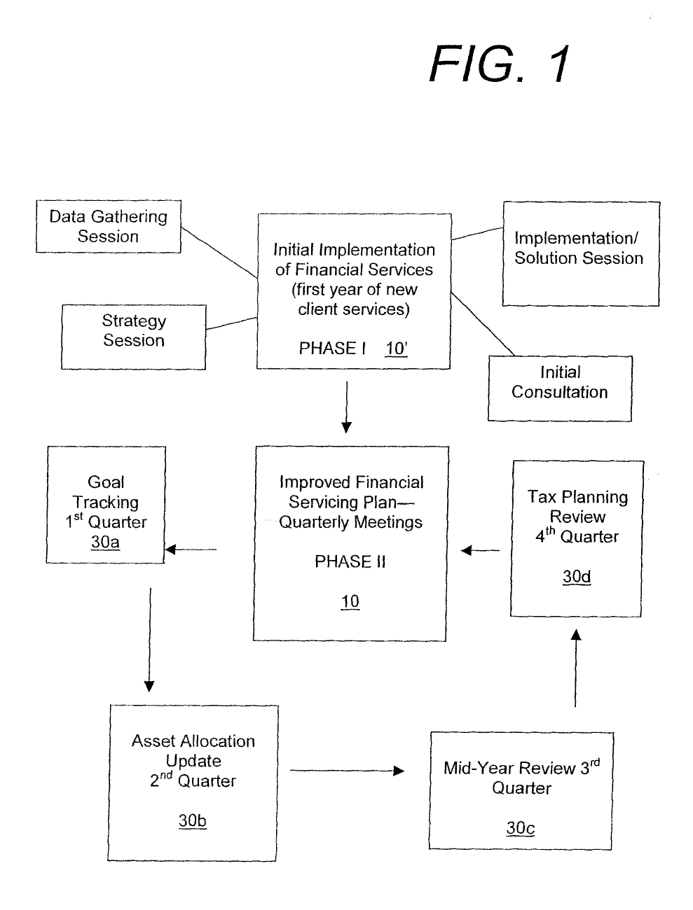

With reference now to the drawings, and initially FIG. 1, there is shown an exemplary overview of a method of providing structured financial planning services in accordance with the invention 10. As shown, there is contemplated an initial implementation period (Phase I) 10′ in which a preliminary advisor-client relationship is established prior to client integration into the improved financial servicing plan of the invention (Phase II) 10 as will be discussed in greater detail hereinbelow.

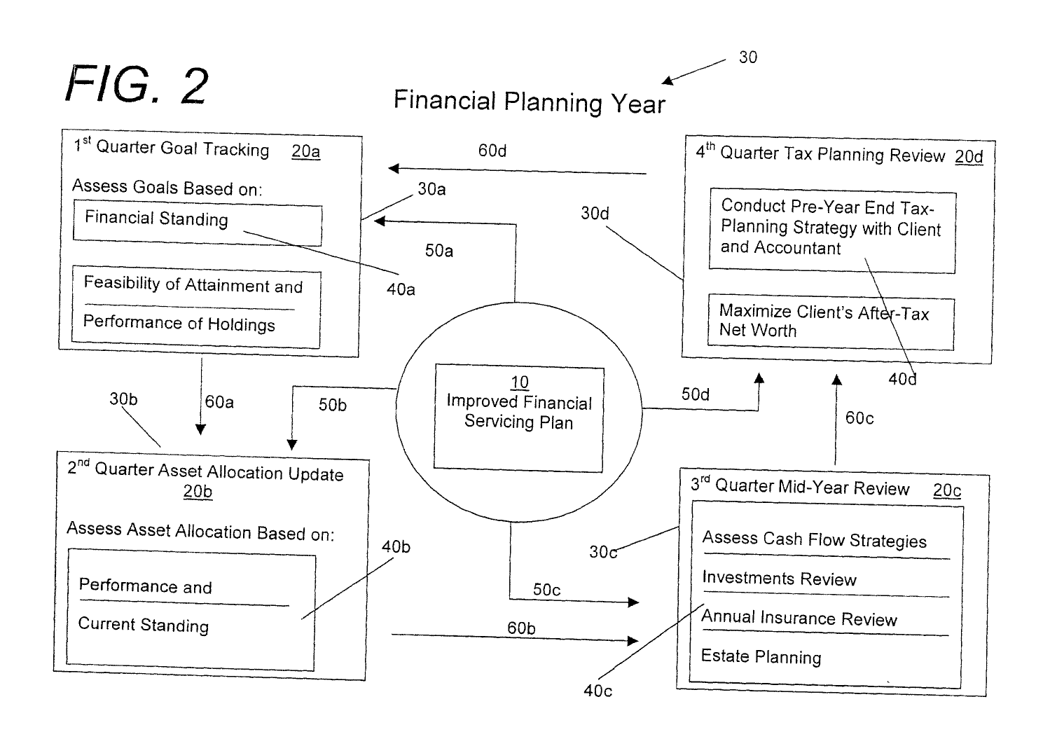

Broadly described, the improved method of providing financial planning services 10 comprises a financial planning year 30 divisible into distinct portions, during which the advisor and client focus on a predetermined, specific financial topic 40 or topics. Preferably, the financial planning year 30 is partitioned as described such that during each predetermined and distinct portion thereof, there takes place an individual meeting 20 between a financial advisor and each of his or her plurality of clients which concentrates substantially exclusively on the predetermined financial topic(s) 40 pre-selected for consideration. In accordance with the preferred method of the invention detailed herein 10, it is contemplated that a financial planning year 30 be divided into quarters, e.g., 30a, 30b, 30c and 30d as shown in FIGS. 1 and 2, such that a first, second, third and fourth individual meeting 20a, 20b, 20c and 20d, between the financial advisor and each of a plurality of clients, focus on first, second, third and fourth predetermined, specific topics, 40a, 40b, 40c and 40d, respectively, during substantially the corresponding first, second, third and fourth quarters 30a, 30b, 30c and 30d of the financial planning year. In this manner, a financial advisor's workflow is synchronized to focus substantially exclusively on only one topic or a select group of topics during each portion of the year. Thus, an improved, controlled method of providing financial services is established which increases retention of advisors and staff, enabling advisors to bring in additional assets and meet with existing clients at regular intervals throughout the financial planning year 30.

As illustrated in greater detailed in FIG. 2, during each portion of the financial planning year 30, a predetermined topic 40 (or group of topics) is selected which is the focus of the advisor-client relationship during that portion. This applies to all clients of an advisor or group of advisors and preferably, the entirety of the firm, such that the financial planning year 30 of all clients beyond the initial implementation of services phase (Phase I) 10′ is synchronized. As should be understood, during a financial planning year 30, the advisor-client relationship focuses on broad financial topics 40, including client goals, asset allocation, investments, estate planning, insurance, tax considerations, etc. It has been discovered that a financial planning year 30 divided into quarters 30a, 30b, 30c, 30d, which incorporate the foregoing topics, among others, in an organized manner, i.e., at substantially regular intervals during exclusive portions of the financial planning year 30, achieves improved advisor-client relations and organization, thus streamlining office workflow and personnel efforts.

As indicated above, it is contemplated that during each of the distinct portions of the financial planning year 30, there will be a meeting 20 between the financial advisor and each of a plurality of clients which focuses substantially exclusively on the selected, predetermined topic or groups of related topics 40 designated for that predetermined portion of the financial planning year 30. Thus, substantially all of an advisor's clients, beyond initial implementation of the advisor-client relationship (which is generally after one year of services) 10′, will be integrated into the improved system 10 such that the financial planning year 30 of each of a plurality of clients is substantially synchronized. It is preferred that a first, second, third and fourth individual meeting, 20a, 20b, 20c and 20d, between the advisor and each of the advisor's clients is held during respective first, second, third and fourth portions of said financial planning year 30a, 30b, 30c and 30d, as shown in FIG. 2.

In accordance with the preferred method of the invention 10, the advisor-client meetings 20 will occur during a financial planning year 30 at substantially regular intervals, i.e., quarterly. While a quarter is generally accepted as being a three-month period of time, it should be understood that quarter or quarterly is intended to serve as a guide for a preferred four-phase year rather than a narrowly defined three-month period of time. It should also be understood that while four quarterly portions are preferred, more or less distinct periods may be provided so long as each portion is devised to focus substantially exclusively on predetermined topics or groups thereof for enhanced organization and streamlining of a financial office's workflow.

As shown in FIG. 1, the improved method of providing financial services 10 is illustrated as a financial planning year of a client starting with a first quarter 30a. It has been discovered that an advisor-client meeting 20a which focuses on the topic of goal assessment 40a during the first quarter of the financial planning year 30a is particularly desirable in that client goals and assets tend to fluctuate yearly depending on such factors as increased or decreased salary, future expenses, together with investment outcomes of the previous financial planning year. Thus, a first quarter meeting 20a, which accommodates a client's year-beginning goals, is preferred. As illustrated in more detail in FIG. 2, the objective of client goal assessment 40a is to concentrate primarily on a client's financial standing, the feasibility of attainment and performance of holdings.

For example, a first quarter meeting 20a would assess a client's current and future financial position relative to his or her goals and objectives. Topics such as cash flow (income minus expenses), net worth (e.g., investments, home, cash and equivalents minus liabilities) and future objectives, would all be addressed. Such future objectives may include education planning, weddings, retirement, etc. Further, topics devoted specifically to second, third, and fourth quarters, 40b, 40c, and 40d, respectively, may be discussed broadly in preparation of upcoming meetings, e.g., 20b, 20c and 20d, including an income tax review (examining past years' tax returns and charitable donations, etc. to facilitate formulation of a tax strategy), estate planning, asset management and the scheduling of an ongoing financial plan.

In accordance with a preferred method of the present invention, the second portion, i.e., second quarter, of the financial planning year 30b of the invention is preferably directed towards asset allocation 40b. In particular, second quarter advisor-client meetings 20b are specifically contemplated to concentrate on past performance and current standing of client assets. That is, present and proposed asset levels will be analyzed and discussed in detail such that any necessary adjustment may be calculated and an appropriate strategy implemented. The object of the asset allocation meeting is to formulate with each client a plurality of asset allocation recommendations, which will serve as the basis for all investment decision making and, in particular, the basis for a third quarter 30c formal advisor-client investment review, wherein second quarter client asset allocation recommendations may be utilized as explained hereinbelow. In this manner, an advisor's office resources will be devoted substantially exclusively to asset allocation, analysis and execution 40b during the second quarter 30b for a predetermined plurality of an advisor's clients.

As shown in FIG. 2, the third portion, i.e., third quarter, of the preferred financial planning year 30c is preferably devoted to a mid-year review of a variety of topics 40c, including cash flow, investments, insurance, and estate planning, etc., desirably by way of a third advisor-client meeting 20c. Such topics have been discovered to be particularly ideal for a third quarterly meeting 20c in that each topic has particular relevance to most, if not all, of a financial advisor's plurality of clients. Further, for a plurality of clients who have been integrated into the method of the invention for a period of months, or successive years for long-standing clients, the third quarter 30c is particularly well-suited for reflection on current year investments and finances following an asset allocation review. Money market and sweep accounts may also be replenished, if necessary, for purposes of paying fees. As should be understood to one of skill in the art, a cash flow assessment would generally involve an evaluation of cash flow strategies and maintenance.

As indicated above, the third quarter investment review preferably involves a formal assessment of investment progress. Second quarter 30b individual client asset allocation recommendations are preferably utilized in advance of the third quarter 30c investment review by the advisor or investment partner to formulate a recommended list of securities which are used to evaluate individual stocks, mutual funds, bonds and other securities in client accounts. While investment review has been highlighted as a preferred element of the third quarter advisor-client meeting 20c, it should be understood that because of the importance of investments, the status of any such client investment is a likely topic of each advisor-client meeting 20 and thus, should not be restricted to any one quarter 30a, 30b, 30c or 30d.

An annual insurance review is also a desirable topic of consideration for the third quarter review 40c, wherein the adequacy of existing insurance and reprojections may be of importance. As detailed in FIG. 2, it is preferred that an annual estate planning review take place, which may be facilitated by creating and utilizing an estate tax balance sheet, which sheets are known in the art. If appropriate, estate/trust coordination and/or recent changes in tax law may be discussed. As should be understood from FIG. 2 and the description herein, the intended purpose of the third quarter, i.e., midyear, review 40c is to assess broad topics applicable to each of an advisor's plurality of clients, while concentrating on those topics which have particular importance to an individual client. Other topics of consideration may be employee stock options, aggregation services, etc.

Lastly, the fourth portion, i.e., fourth quarter, advisor-client meeting 20d of the financial planning year is preferably devoted substantially exclusively to a tax planning review 40d. In preparation of such a review, it is desirable to obtain any relevant information from a client beforehand such that an accountant may be contacted and present, if necessary. A preliminary year-end tax planning strategy with client and accountant may be developed so as to maximize a client's after-tax net worth.

In accordance with the foregoing method, during each portion of the financial planning year 30, a predetermined topic (or group of topics) 40 is selected which is the focus of the advisor-client relationship during that portion of the year. When employing the preferred method having a financial planning year comprising first, second, third and fourth quarters, there are preferably corresponding first, second, third and fourth meetings 20a, 20b, 20c and 20d, for each of a plurality of clients, which address predetermined, distinct topics 40a, 40b, 40c, and 40d therein. Meetings 20a, 20b, 20c and 20d, between an advisor and each of a plurality of clients, occur preferably substantially during the corresponding first, second, third and fourth portions of the financial planning year 30a, 30b, 30c, and 30d, respectively. This applies to all clients of an advisor and, preferably, the entirety of the firm, such that the financial planning year of all clients beyond the initial implementation of services phase (Phase I) 10′ is synchronized. As should be apparent, the method of the present invention 10 which comprises a financial planning year 30 divided in a manner so as to synchronize advisor-client meetings 20 and topics 40 thereof, provides for improved customer relations and management capabilities allowing financial advisors and other office personnel to manage workflow more efficiently and with improved quality.

As indicted above, it is intended that prior to the implementation of the improved financial service plan of the invention 10, an initial implementation period 10′ is concluded which comprises conventional, introductory advisor-client sessions which may include an initial consultation, data gathering session, strategy session, implementation session, etc., all or some of which may be conducted through in-person meetings, as shown in FIG. 1. It is preferred that the initial implementation period 10′ extends approximately one year such that a client is not transitioned into the quarterly planning year of the preferred method 20 until the expiration of such period, or a lesser period of several months. Traditionally, such initial services 10′ are freely provided by the advisor with the intent that a fee service relationship will ultimately develop. Thus, the improved, controlled financial planning year 30 of the method detailed herein and illustrated in FIG. 2 is specifically contemplated to be a fee service, wherein clients are charged depending upon the level of service desired and the complexity thereof. Generally, an ongoing fee structure for premium service level clients ranges from $1,500 to $2,500 per year, wherein fees may be renewed or billed annually such that the minimum plan count for the following year may be determined in advance. Alternatively, the method 10 described herein can be utilized in connection with the initial phase of advisor-client relations 10′, such that the entirety of a financial advisor's office, clients, staff, workflow, etc. are substantially synchronized.

Adoption and implementation of the financial planning method 10, beyond the initial implementation period 10′ illustrated as Phase I in FIG. 1 may vary, as not all clients will be integrated into the improved financial servicing plan precisely at the same time, e.g., during the first quarter 30a. Accordingly, it should be understood that integration of a client within the improved financial planning system 20 in accordance with the invention could occur during any of the predetermined portions of the financial planning year, as illustrated by arrows 50a, 50b, 50c and 50d. In this manner, advisor-client meetings or consultations would occur successively as illustrated, for example, by arrows 60a, 60b 60c and 60d, at substantially regular intervals over a financial planning year and repeated over successive years throughout the life of the advisor-client relationship.

It should also be understood that more or less than four yearly meetings will occur depending upon a client's desires and when a particular client is integrated into the improved, controlled financial servicing method of the invention. For instance, if a client is integrated into the system at arrow 50b, as shown in FIG. 2, then ideally two or three meetings will occur during the particular financial planning year 30. Further, if a client chooses to have less than the preferred four meetings per year, costs for such meetings can be prorated.

The benefits of the improved, controlled financial service plan over conventional systems are many. In addition to improved efficiency and synchronized workflow, the system 10 can be designed to focus on the needs of higher net-worth/asset individuals, resulting in greater investment balances. Of particular advantage, both the advisor and staff develop an expertise in matters to be handled during each quarterly period 30a, 30b, 30c, and 30d, such that answering client questions and implementing particular strategies takes less time. With regard to clients, expectations are set in advanced such that clients approach meetings with increased attention. In addition, there is less need for clients to focus on finances between service meetings, as upcoming advisor-client meetings 20 are preferably scheduled in advance, during a first portion, or quarter of the financial planning year 30a.

As should be understood, the term financial advisor as utilized herein is intended to include any such person the primary responsibility of which is to provide personal, financial assistance to a plurality of clients, whether such person is referred to as financial advisor, consultant, planner, broker, agent, etc. Further, while a preferred embodiment of the invention has been described, it will be apparent to those of skill in the art that many more embodiments and manners of implementing the improved method of providing financial planning services 10 are possible and within the scope of this invention. For example, while four quarterly portions 30a, 30b, 30c and 30d of a financial planning year have been detailed herein, the financial planning year 30 may be divided into more or less portions as desired, so long as each distinct portion of a financial planning year focuses substantially exclusively on predetermined, distinct topics 40 such that the objects and advantages of the method of the present invention may be realized. Further, the focus/content of client-advisor meetings 20 can and will vary depending on circumstances particular to each client, such as income, age, existing assets, number of dependents, etc., so long as the general categories of topics 40 are substantially identical for a plurality of clients. Accordingly, the scope of the invention is to be defined by the appended claims.

What is claimed is:

1. A system for providing personal financial planning services, comprising:
processing means operative to gather and store data at predetermined and distinct times in a financial planning year data concerning at least one of a plurality of financial planning clients, said data concerning a predetermined and substantially distinct topic, said topic being chosen from the group of topics comprising client goals, asset allocation, investments, estate planning, insurance, and tax considerations;
processing means operative to provide outputs at said predetermined and distinct times concerning a topic selected from said group of topics, for at least one of said plurality of financial planning clients; and
processing means operative to substantially synchronize said data gathering, storing, and output for each of said plurality of clients, such the topics selected for data gathering and output for each of said plurality of clients is substantially exclusively devoted to substantially identical, predetermined and substantially distinct topics during each of said predetermined and distinct times in said financial planning year.
